(19) United States
(12) Patent Application Publication
(10) Pub. No.: US 2004/0201539 A1
(43) Pub. Date: Oct. 14, 2004

(54) RADIO FREQUENCY IDENTIFICATION SYSTEM AND ANTENNA SYSTEM

(76) Inventor: Robert G. Yewen, Brampton (CA)

Correspondence Address: MOORE & VAN ALLEN, PLLC, 2200 W MAIN STREET, SUITE 800, DURHAM, NC, 27705, US

(21) Appl. No.: 10/249,438

(22) Filed: Apr. 9, 2003

(51) Int. Cl. H01Q 21/00

(52) U.S. Cl. 343/867; 343/742

(57) ABSTRACT

A radio frequency identification (RFID) system is disclosed. The RFID system may include a plurality of antenna systems. Each pair of antenna systems may form an interrogation zone or write zone. A power splitter, switch, multiplexer or the like may alternately drive each antenna system of each pair of antenna systems to expand the interrogation zone or write zone for a selected or given power or to reduce a signal strength or power to transmit over a predetermined range of the interrogation or write zone.

### BACKGROUND OF INVENTION

### FIELD OF THE INVENTION

The present invention relates to radio frequency identification (RFID), antennas and the like, and more particularly to a RFID system and an antenna system that may be used in a RFID system or other applications.

Radio frequency identification (RFID) systems may be used to control and monitor the movement of people and objects. RFID systems work in conjunction with a transponder or tag that may be placed on a person or object to control movement of the person or object or to monitor and record movement of the person or object. When a transponder associated with a person or object enters an interrogation zone formed by a RFID system, the RFID system may transmit an interrogation signal to the transponder. The interrogated transponder may then send a return signal to the RFID system. Depending upon the response from the transponder, the person or object associated with the transponder may be permitted to move from one area to another. The RFID system may also keep track of the movement of an object or person based on the transponder's responses and locations of the interrogating RFID systems. For example, RFID systems may be used to control access to particular areas, such as vehicles to a parking garage, toll highways, bridges or the like. RFID systems may also be used to control or monitor movement of products through a factory or warehouse system, shoplifting control, access of people to certain areas, such as secure areas, a ride at an amusement park or the like. RFID systems may have applications in any situation where movement or access needs to be controlled or monitored.

The amount of power or signal strength that may be generated by an RFID system may be limited so as to minimize electromagnetic interference of other electronic devices. As the power or signal strength of a RFID system is reduced, the effective distance or range that the system can interrogate a transponder is correspondingly reduced. Additionally, power or signal strength can be lost by signal or power reflections in the system if the RFID system antenna elements are not accurately inductively matched to each other and the system. The RFID system may also operate ineffectively or fail to interrogate a transponder and receive a response if the orientation of the antenna element of the transponder has a polarization or electromagnetic field orientation that is different or misaligned relative to the RFID system antenna elements.

Accordingly, there is a need to provide a RFID system and antenna system that provides an extended range of operation or increased interrogation zone or write zone for a given or selected power or signal strength, or conversely, the power or signal strength may be reduced for a predetermined size or range of transmission in an interrogation zone or write zone. There is also a need to provide a RFID system and antenna system that may permit a simplistic means to accurately match the inductance of the antenna elements to each other and the system. There is a further need to provide a RFID system and antenna system that permits communication with a RFID transponder in any orientation of an antenna element of the transponder.

### SUMMARY OF INVENTION

In accordance with an embodiment of the present invention, an antenna system may include a first antenna element and a second antenna element connected in parallel with the first antenna element. A balun tuning device or circuit may be provided to balance an inductance between the first and second antenna elements.

In accordance with another embodiment of the present invention, an antenna system may include a first antenna element and a second antenna element connected in parallel with the first antenna element. A balun tuning device or circuit may be connected in parallel with the first and second antenna elements. One terminal or node of the balun device may be slidably coupled to a common side of the first and second antenna elements to balance an inductance between the first and second antenna elements.

In accordance with another embodiment of the present invention, a balun device may include a tuning circuit and a bracket to couple the tuning circuit to first and second antenna elements. The bracket may be movable relative to the first and second antenna elements to balance an inductance between the first and second elements.

In accordance with another embodiment of the present invention, a radio frequency identification (RFID) system may include a plurality of antenna systems. Each pair of antenna systems may form an interrogation zone or write zone. A power splitter may alternately drive each antenna system of each pair of antenna systems to expand each interrogation zone or write zone for a given or selected power or to reduce power or signal strength to transmit or operate over a predetermined range of the interrogation or write zone.

In accordance with another embodiment of the present invention, a radio frequency identification (RFID) system may include a plurality of antenna systems, each pair of antenna systems forming an interrogation zone or write zone. Each antenna system of each pair may include a first antenna element and a second antenna element connected in parallel with the first antenna element. A balun tuning device or circuit may be slidably coupled to a common side of the first and second antenna elements to balance an inductance between the first and second antenna elements. A power splitter may be included to alternately drive each antenna system of each pair of antenna systems to expand the interrogation zone or write zone for a selected power or to reduce a signal strength or power to transmit or operate over a predetermined range of the interrogation or write zone.

In accordance with another embodiment of the present invention, a method of communicating with a transponder may include alternately driving each antenna system of at least one pair of antenna systems forming an interrogation zone or write zone. The method may also include interrogating any transponder in the interrogation zone or write zone. The method may further include controlling movement of an object or person associated with the transponder in the interrogation zone or write zone in response to a signal from the transponder.

In accordance with another embodiment of the present invention, a method of communicating with a transponder may include expanding an interrogation zone or write zone for a selected power or reducing a signal strength or power for a predetermined size or range of the interrogation zone or write zone by alternately driving each antenna system of a pair of antenna systems forming the interrogation zone or write zone. The method may also include one of interrogating or writing into a memory of any transponder in the interrogation zone or write zone.

In accordance with an embodiment of the present invention, a method of making an antenna system may include forming a first antenna element and forming a second antenna element connected in parallel with the first antenna element. A balun tuning device or circuit may be formed connected in parallel with the first and second antenna elements. One terminal or node of the balun may be slidably coupled to a common side of the first and second antenna elements to balance an inductance between the first and second antenna elements.

In accordance with another embodiment of the present invention, a method of making a balun device may include forming a tuning circuit and forming a bracket to connect the tuning circuit to first and second antenna elements. The bracket may be movable relative to the first and second antenna elements to balance an inductance between the first and second elements.

In accordance with another embodiment of the present invention, a method of making a RFID system may include forming a plurality of antenna systems, each pair of antenna systems forming an interrogation zone or write zone. The method may also include forming a power splitter to alternately drive each antenna system of each pair of antenna systems to expand the interrogation zone or write zone for a selected power or to reduce a signal strength or power for a predetermined detection or operating range within the interrogation or write zone.

### BRIEF DESCRIPTION OF DRAWINGS

FIG. 1A is a block diagram of a RFID system in accordance with an embodiment of the present invention.

FIGS. 1B and 1C are a detailed view of the antenna systems of FIG. 1A illustrating the change in the interrogation zone or area when the antenna systems are switched between active and passive modes.

FIG. 2A is an illustration of an exemplary antenna system in accordance with an embodiment of the present invention.

FIG. 2B is an illustration of an example of a balun device or circuit coupled to an antenna system or structure in accordance with an embodiment of the present invention.

FIG. 3 is a schematic diagram of an exemplary balun circuit or device in accordance with an embodiment of the present invention.

FIG. 4 is a flow chart of a method of communicating with a transponder or the like in accordance with an embodiment of the present invention.

FIG. 5 is a flow chart of a method of communicating with a transponder or the like in accordance with another embodiment of the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

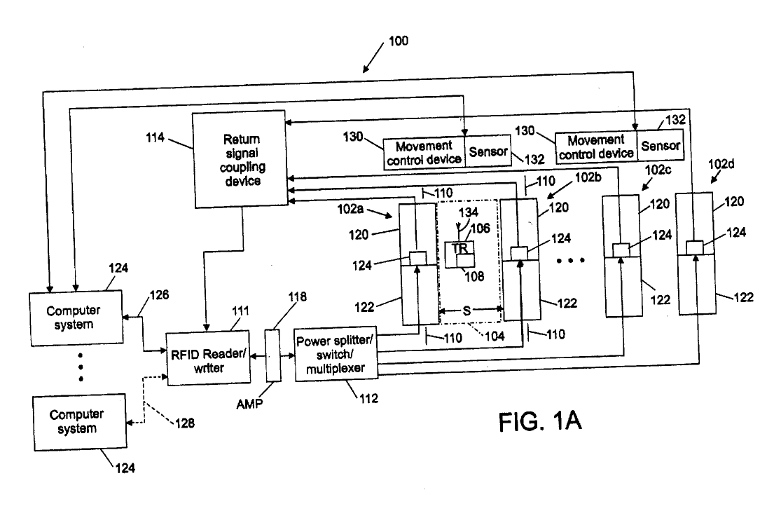

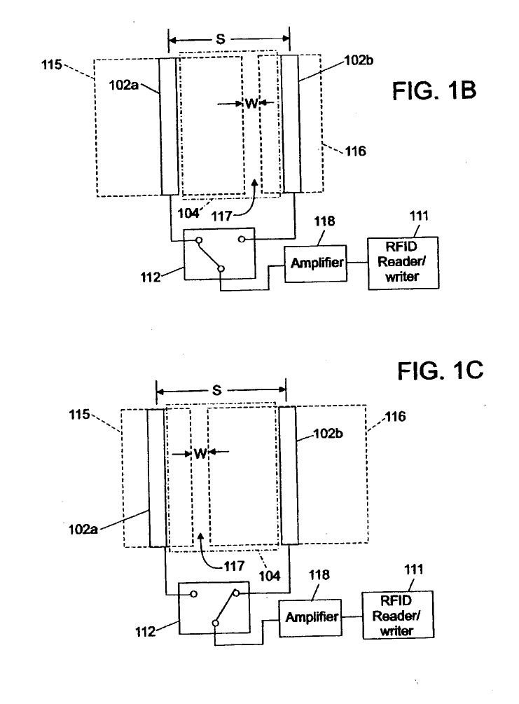

FIG. 1A is a block diagram of a RFID system 100 in accordance with an embodiment of the present invention. The RFID system 100 may include a plurality of antenna systems 102a-102d. The RFID system 100 may include a single pair of antenna systems 102a and 102b or a plurality of pairs of antenna systems 102a/102b, 102b/102c and 102c/102d and so forth. Each pair of antenna systems 102a/102b, 102b/102c and 102c/102d may form an interrogation zone 104 or write zone illustrated by the broken or chain line in FIG. 1A. In the interrogation zone 104 or write zone, a transponder 106 may be interrogated or data may be written into a memory 108 of the transponder 106.

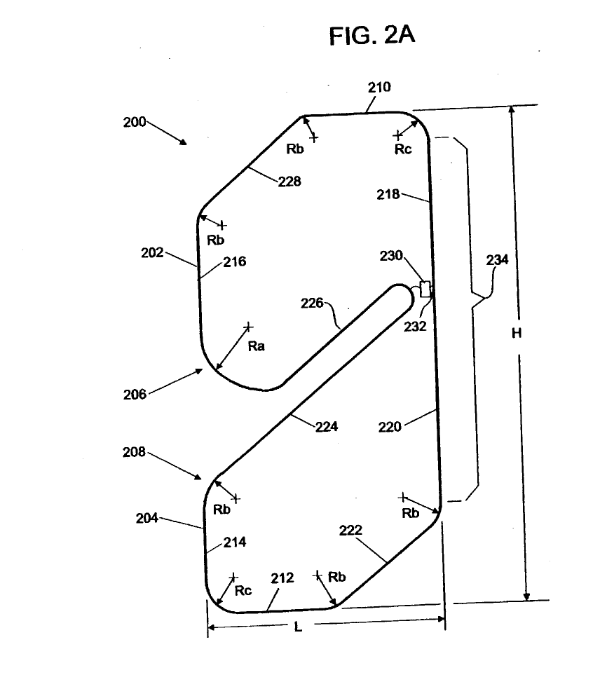

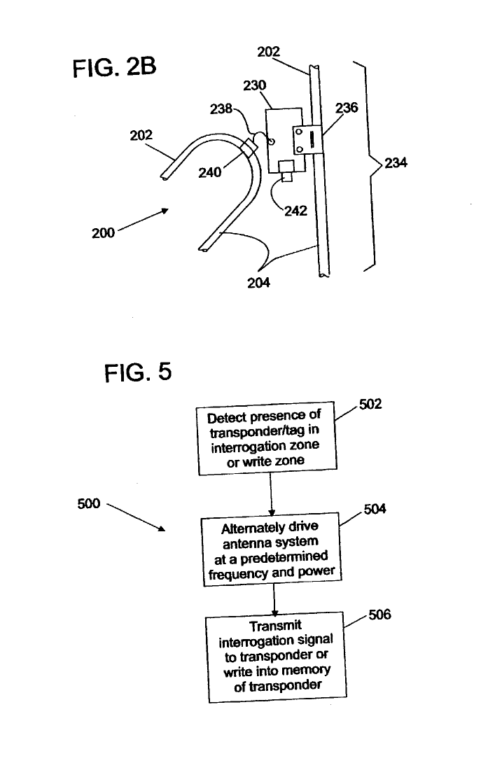

Referring also to FIG. 2A, an exemplary antenna system 200 is illustrated that may be used for each of the antenna systems 102 in FIG. 1A. Each antenna system 102 may define a plane 110 extending perpendicular out of the page of FIG. 1A. In FIG. 2A, the plane of the antenna system 200 is the same as the plane of the page. Each of the antenna systems 102 (FIG. 1A) may be aligned adjacent to one another with their planes 110 substantially parallel to one another. Each pair of antenna systems 102a/102b, 102b/102c and 102c/102d (102a-102d) may be spaced at a selected spacing “S” from one another. Additionally, each antenna system 102 or 200 (FIG. 2A) may have a predetermined length “L” and height “H” as best shown in FIG. 2A in the plane of the antenna system 102 or 200. The spacing S and length L and height H of each pair of antenna systems 102 may define the interrogation zone 104 or write zone that may form substantially a rectangular box.

A RFID reader 111 or writer or combination reader/writer may be connected to each antenna system 102 by a power splitter 112 to alternately connect the RFID reader 111 to each antenna system 102 of each pair 102a-102d and thereby alternately drive or activate the respective antenna systems 102a-102d. The power splitter 112 may be a switch, multiplexer or the like to operate at a predetermined frequency to alternately activate each antenna system 102 of each pair 102a-102d at least once before the RFID transponder 106 can traverse the interrogation zone 104 or write zone. In operation, the RFID reader/writer 111 may generate a signal to interrogate or write to any transponder 106 in the interrogation zone 104. The power splitter 112 may transfer or switch the signal from the RFID reader/writer 111 to an active one of the antenna systems 102 of each pair of antenna systems 102a-102d. The active antenna system 102 will then transmit the signal to any transponder 106 in the interrogation zone 104. The active antenna system 102 of each pair may receive a response signal from the transponder 106 that may be transmitted back to the RFID reader/writer 111. As described in more detail below, the passive antenna system 102 of each pair may also receive any response signal from any interrogated transponder 106 in a detection or operating range of the passive antenna system 102. The passive antenna system 102 may be connected to the RFID reader/writer 111 by a return signal coupling device 114 or the like to transfer the response signal from any interrogated transponder 106 back to the RFID reader/writer 111. The return signal coupling device 114 may be a Feig™ LR 200, Texas Instruments ™ 6550 or the like.

Referring also to FIGS. 1B and 1C, these Figures illustrate how transponder or tag detection or operating ranges 115 and 116 of the active and passive antenna systems 102 may change in the interrogation zone 104 for a selected power or signal strength when the antenna systems 102 are switched between active and passive modes by the splitter 112. In FIG. 1B, the antenna system 102a may be driven or active at a selected power to provide the transponder detection range 115. When active, the antenna system 102a may transmit interrogation signals and may detect or receive a response signal from any transponder in the range 115. While the antenna system 102a is active, the antenna system 102b may be passive. However, mutual electromagnetic coupling from the active antenna system 102a may cause the passive antenna system 102b to have a passive transponder detection range 116 that may be much smaller than the active transponder range 115. The passive antenna system 102b may also detect or receive a response signal from any transponder that may be in or close to the passive detection range 116. Any response signal received by the passive antenna system 102b may be sent back to the RFID reader 111 via the return signal coupling device 114 (FIG. 1A).

In FIG. 1C, the splitter 112 may switch after a predetermined time period to connect the RFID reader 111 to activate the antenna system 102b to interrogate or write to any transponders in or near to the detection range 116. While antenna system 102b is in an active mode, the antenna system 102a will be in a passive mode. Similar to that described above, the transponder detection range 115 of the now passive antenna system 102a (that may be caused by electromagnetic coupling from the active antenna system 102b) may be substantially smaller than the detection range 116 of the now active antenna system 102b. As previously described, the power splitter 112 may operate at a predetermined frequency to alternately drive the antenna systems 102a and 102b at least once before a transponder may traverse the interrogation zone 104.

The signal strength or power transmitted by the active antenna system 102 may be at a level that a dead zone 117 may exist between the active and passive detection ranges 115 and 116 where transponder or tag detection through the interrogation zone 104 may be weakest. The width “w” of the dead zone 117 may be a function of the signal strength or transmit power and the spacing “S” between the antenna systems 102a and 102b. The dead zone 117 width may be decreased by increasing the power or moving the antenna systems 102a and 102b closer together. However, because the present invention switches between the antenna system pairs 102a-102d at a predetermined frequency to activate each antenna system 102 of a pair before a transponder can traverse the interrogation zone 104, a dead zone 117 of a selected width “w” may be acceptable, thus permitting an expanded interrogation zone for a selected power level. Accordingly, depending upon the application, the system 100 of the present invention may be designed to operate at a lower power, a greater spacing “S” between antenna systems 102 or a wider dead zone for a selected power, or some combination of all three parameters.

An enhancing amplifier 118 may be used to set the desired power level of the detection zone 115 or 116 of the active antenna system 102. The enhancing amplifier 118 may amplify the signal in both directions and may be part of the RFID reader/writer 111 or the power splitter 112 or may be a separate component as shown in FIGS. 1A-1C. By alternating the active and passive antenna system between adjacent antenna systems 102 the overall system 100 may provide a maximum interrogation zone 104 within governmental power limits while still using an economical off-the-shelf RFID reader/writer 111. Additionally, switching between active and passive antenna systems 102 may improve interrogation of transponders and receipt of response signals from an interrogated transponder. This may be because the cutting angles of the lines of flux or orientation of the electromagnetic fields from the alternating antenna systems 102 may have better coupling to an antenna of a transponder.

Referring back to FIG. 1A, each antenna system 102 may include a first antenna element 120 and a second antenna element 122 that may be connected in parallel with the first antenna element 120. A balun device 124 or balun tuning circuit may be coupled in parallel with both the first and second antenna elements 120 and 122 to balance an inductance between the first and second antenna elements 120 and 122. The balun device 124 may be connected to the power splitter 112 to drive the antenna elements 120 and 122.

The RFID system 100 may include at least one computer system 124 to control operation of the RFID system 100. The computer system 124 may be coupled to the RFID reader/writer 111 by a hardwire connection as illustrated by the solid arrow 126 or by a wireless connection or the like as illustrated by the dashed arrow 128 in FIG. 1A. The computer system 124 may be connected to a movement control device 130, sensor 132 or the like. The movement control device 130 may control movement of an object or person associated with the transponder 106 through the interrogation zone 104. The movement control device 130 may include a turnstile (not shown in FIG. 1), light signaling system or the like (not shown). The movement control device 130 may also include an actuator arm or the like (not shown) to move a product or similar object to a different location or any sort of mechanism to direct or control movement of people or objects. The sensor 132 may be any sort of infrared sensor, motion sensor or similar device to detect the presence of a transponder 106 or a person or object associated with a transponder 106. The sensor 132 may signal the computer system 124 to cause the RFID reader/writer 111 to generate an interrogation signal. Alternatively, a signal may be generated by the RFID reader/writer 111 to write data or information into the memory 108 of the transponder 106 or to read data from the memory 108 of the transponder 106.

Referring back to FIG. 2A which is an illustration of an exemplary antenna system 200 in accordance with a embodiment of the present invention, the antenna system 200 may include a first antenna element 202 and a second antenna element 204. The first and second antenna elements 202 and 204 may be the same as first and second antenna elements 114 and 116 in FIG. 1 and may be connected in parallel. The first and second antenna elements 202 and 204 may be formed to substantially avoid or minimize a concentration of electromagnetic energy or fields at locations where each of the elements 202 and 204 are bent or shaped to respectively form a first antenna loop 206 and a second antenna loop 208. Accordingly, the first and second antenna elements may each be formed with each angle having a predetermined radius “Ra-Rc” to substantially avoid or minimize the effects of 90 degree angles and thereby minimize a concentration of electromagnetic energy or fields when the antenna system 200 is radiating electromagnetic energy or transmitting signals. By not concentrating the electromagnetic energy at the bends or angles forming the elements 202 and 204, the antenna system 200 of the present invention may direct more electromagnetic energy into the interrogation or write zone 104 (FIG. 1) to more effectively and with reduced power or signal strength interrogate any transponder in the zone 104 or write data into the memory 108 of the transponder 106. Additionally, the first and second antenna elements 202 and 204 may each be formed to provide horizontal portions 210 and 212, vertical portions 214, 216, 218 and 220 and diagonal portions 222, 224, 226 and 228. The horizontal portions 210-212, vertical portions 214-220 and diagonal portions 222-228 may respectively provide electromagnetic fields that are oriented horizontally, vertically and diagonally to communicate with any orientation of a antenna element 134 (FIG. 1A) of a transponder 106 in the interrogation or write zone 104.

While the antenna elements 202 and 204 are shown to have a unique shape in FIG. 2, other shapes such as hexagons or the like could be used as well. Any shape that substantially avoids or minimizes concentration of the electromagnetic fields and provides horizontal, vertical and diagonal electromagnetic fields may be used. The elements 202 and 204 may be made from a conductive material such as copper, aluminum or a conductive alloy.

The elements 202 and 204 may be housed in a protective frame or covering (not shown in FIG. 2A) to protect the elements 202 and 204 and to provide a structure to retain the elements in a desired position or location.

A balun device 230 or balun tuning circuit may be coupled in parallel with the first and second antenna elements 202 and 204. The balun device 230 may be the same as the balun device 118 in FIG. 1. One side or terminal 232 of the balun device 230 may be movably coupled to a common side 234 of the first and second antenna elements 202 and 204 to balance an inductance between the first and second antenna elements 202 and 204. The inductance of antenna elements 202 and 204 may be balanced to substantially minimize any power or signal reflections that may reduce the transmitted power of any signals transmitted to interrogate a transponder or write data into a memory of a transponder.

FIG. 2B is an illustration of an example of the balun device 230 or circuit coupled in parallel with each of the antenna elements 202 and 204 in accordance with an embodiment of the present invention. The balun device 230 may include a sliding tuning bracket 236 adapted to couple to the common side 234 of the first and second antenna elements 202 and 204. The sliding tuning bracket 236 may slide along the common side 234 to accurately balance an inductance between the first and second antenna elements 202 and 204. Another side or terminal 238 of the balun device 230 may be fixedly coupled to the first and second antenna elements 202 and 204 by a clamp mechanism 240 or the like at a union of the first and second antenna elements 202 and 204 that resembles an end of a trombone slide.

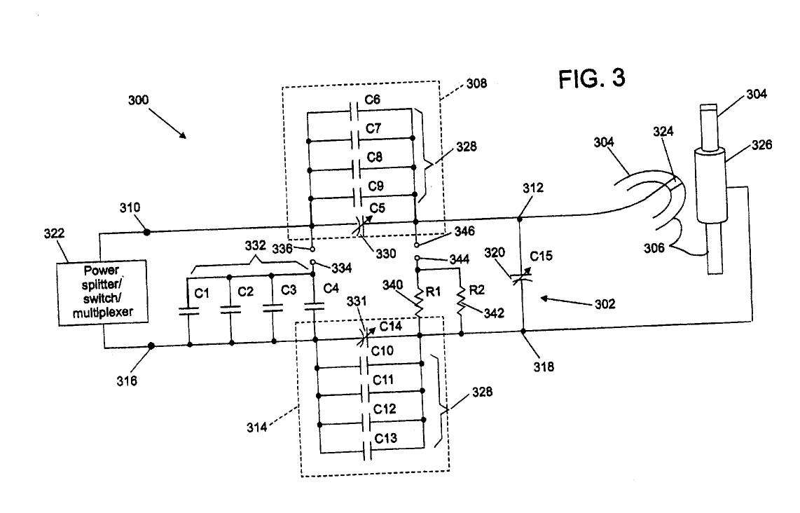

FIG. 3 is a schematic diagram of an exemplary balun device or balun tuning circuit 300 in accordance with an embodiment of the present invention. The balun tuning circuit 300 may be the same as the balun circuit 230 in FIGS. 2A and 2B. The balun circuit 300 may include an adjustable capacitive network 302 to fine tune an inductive balance between the first and second antenna elements 304 and 306. The capacitive network may be fine tuned by an adjustment knob 242 in FIG. 2. The first and second antenna elements 304 and 306 may be the same as elements 202 and 204 in FIGS. 2A and 2B. The balun tuning circuit 300 may include a first capacitance 308 that may be connected between a first node or terminal 310 and a second node or terminal 312. A second capacitance 314 that may be connected between a third node or terminal 316 and a fourth node or terminal 318. A third capacitance 320 may be connected between the second node 312 and the fourth node 318. At least one of the first capacitance 308, second capacitance 314 and third capacitance 320 may be adjustable to fine tune an inductive balance between the first and second antenna elements 304 and 306.

The first node 310 and the third node 316 may be connected to a power splitter 322, switch, multiplexer or the like. The power splitter 322 may be the same as the power splitter 112 in FIG. 1. The second node 312 and the fourth node 318 may be coupled in parallel with each of the first antenna element 304 and the second antenna element 306. The second node 312 may be attached to a union 324 of the first and second elements 304 and 306. The fourth node 318 may be connected to a sliding tuning bracket 326 to slidably couple the balun tuning circuit 300 to a common side of the first and second elements 304 and 306. The sliding tuning bracket 326 may be the same as the sliding tuning bracket 236 in FIG. 2B. Alternatively, the second node 312 could be connected to the bracket 326 and the fourth node 318 connected to the union 324. In another embodiment, the first node 310 and the third node 316 may be respectively connected to the union 324 and bracket 326 and the second and fourth nodes may be connected to the power splitter 322.

The first capacitance 308 and the second capacitance 314 may each include a plurality 328 of capacitors each connected in parallel with a variable or adjustable capacitor 330 and 331 respectively, to finely adjust or tune the inductive balance between the first and second antenna elements 304 and 306.

The balun tuning circuit 300 may further include another plurality 332 of capacitors each connected in parallel between the third node 316 and a fifth node or terminal 334. A sixth node or terminal 336 may be connected to the first node or terminal 310. The fifth node or terminal 334 and the sixth node or terminal 336 may be used to test the balun tuning circuit 300. The fifth and sixth nodes 334 and 336 may be short circuited by a jumper (not shown) to isolate a portion of the balance tuning circuit 300 for testing or for other purposes.

The balun tuning circuit 300 may include a first resistor 340 connected in parallel with at least a second resistor 342 between the fourth node 318 and a seventh node or terminal 344. An eighth node or terminal 346 may be connected to the second node 312. The seventh node 344 and the eighth node 346 may be used to test the balun circuit 300 or for other purposes. The seventh node 344 and the eighth node 346 may be short circuited by a jumper (not shown) to isolate a portion of the balance tuning circuit 300 for testing purposes or other purposes.

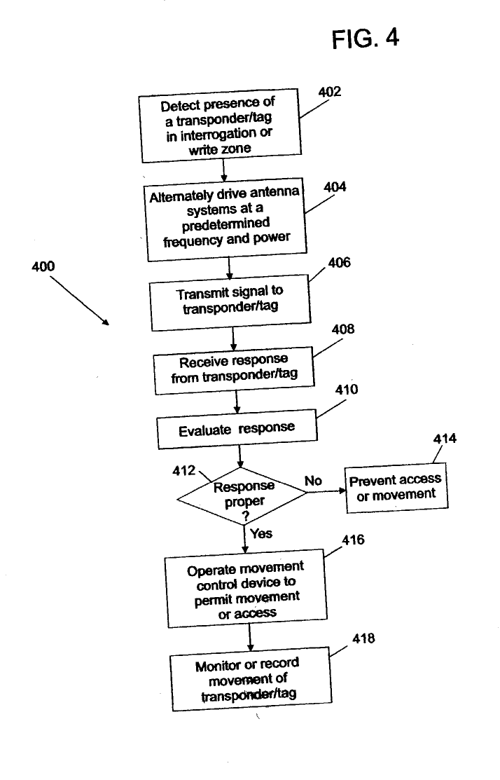

FIG. 4 is a flow chart of a method 400 of communicating with a transponder or the like, similar to transponder 106 (FIG. 1A), in accordance with an embodiment of the present invention. The method 400 may be performed by a RFID system such as the system 100 in FIG. 1A. In block 402, the presence of a transponder or tag in an interrogation or write zone may be detected. The detection of the transponder may be done with a sensor or the like similar to the sensor 132 in FIG. 1A. In block 404, each antenna system in a pair of antenna systems, similar to antenna systems 102 and 200 in FIGS. 1A-1C and 2A, may be alternately driven or activated as previously discussed at a predetermined frequency and power or signal strength. The antenna systems 102 of each pair may be continuously, alternately driven when the RFID system 100 is active or the antenna systems 102 may be alternately driven only after detecting a transponder 106 in the interrogation or write zone 104. A signal may be transmitted to interrogate the transponder or tag in block 406. As previously discussed with respect to FIG. 1A, the RFID reader 111 may generate an interrogation signal that may be switched by the power splitter 112 to an active antenna system 102 of a pair of antenna systems 102a-102d. The active antenna system 102 may then transmit the interrogation signal to the transponder 106. In block 408, a response signal from the transponder 106 may be received by the active or passive antenna system 102 of the pair. The response signal may be evaluated in block 410. The response may be evaluated by the computer system 124. If the response is determined to be improper in block 412, the method 400 may advance to block 414 and movement of the object or person associated with the transponder 106 may be prevented movement or access. If the response is determined to be proper in block 412, the method 400 may advance to block 416 and a movement control device, such as movement control device 130 in FIG. 1A, may operate to permit movement or access of the object or person associated with the transponder 106. In block 418, movement or access of the transponder 106 may be monitored or recorded. The blocks in method 400 are not intended to be in any particular order.

FIG. 5 is a flow chart of a method 500 of communicating with a transponder, similar to the transponder 106 in FIG. 1A or the like, in accordance with another embodiment of the present invention. The method 500 may also be performed by an RFID system such as the system 100 in FIG. 1A. In block 502, the presence of a transponder 106 or tag in an interrogation or write zone 104 may be detected. The presence of the transponder 106 may be detected by a sensor 132 or the like. In block 504, each antenna system 102 of each pair of antenna systems 102a-102d may be alternately driven or activated at a predetermined frequency and power to interrogate a transponder 106 or to write data to a transponder 106 similar to that previously described. In block 506, an interrogation signal may be transmitted by an active one of the pair of antenna systems 102 to the transponder 106. Alternatively, a data signal may be transmitted to the transponder 106 to write data into the memory 108 of the transponder 106. The blocks in method 500 are not intended to be in any particular order.

Although specific embodiments have been illustrated and described herein, those of ordinary skill in the art appreciate that any arrangement which is calculated to achieve the same purpose may be substituted for the specific embodiments shown and that the invention has other applications in other environments. For example, while the antenna system and balun device of the present invention may have been described with respect to use in a RFID system, the antenna system and balun device may have other applications. The antenna system and balun device may be used in any application where multiple antenna elements may be employed and precise inductance balancing of the antenna elements may be desired. This application is intended to cover any adaptations or variations of the present invention. The following claims are in no way intended to limit the scope of the invention to the specific embodiments described herein.

1. An antenna system, comprising:
a first antenna element;
a second antenna element connected in parallel with the first antenna element; and
a balun tuning circuit to balance an inductance between the first and second antenna elements.

2. The antenna system of claim 1, wherein the first and second antenna elements are formed to substantially avoid a concentration of electromagnetic energy at locations where each of the elements are shaped to respectively form a first antenna loop and a second antenna loop.

3. The antenna system of claim 1, wherein the first and second antenna elements are each formed with each angle having a predetermined radius to minimize a concentration of electromagnetic energy when the antenna system is radiating electromagnetic energy.

4. The antenna system of claim 1, wherein the first and second antenna elements are formed to communicate with a radio frequency identification (RFID) transponder in any orientation of an antenna element of the transponder.

5. The antenna system of claim 1, wherein the first and second antenna elements are each formed to provide electromagnetic fields that are oriented vertically, horizontally and diagonally.

6. The antenna system of claim 1, wherein the first and second antenna elements are adapted to transmit and receive radio frequency identification (RFID) signals.

7. The antenna of claim 1, wherein the balun tuning circuit is connected in parallel with the first and second antenna elements.

8. The antenna system of claim 7, wherein one side of the balun tuning circuit is movably coupled to a common side of the first and second antenna elements to balance an inductance between the first and second antenna elements.

9. The antenna system of claim 1, further comprising a sliding tuning bracket adapted to couple the balun tuning circuit to the first and second antenna elements, wherein the sliding tuning bracket is adapted to slide along a common side of the first and second antenna elements to balance an inductance between the first and second antenna elements.

10. The antenna system of claim 1, wherein the balun tuning circuit comprises an adjustable capacitive network to fine tune an inductive balance between the first and second antenna elements.

11. The antenna system of claim 1, wherein the balun tuning circuit comprises:
a first capacitance connected between a first node and a second node;
a second capacitance connected between a third node and a fourth node; and
a third capacitance connected between the second node and the fourth node.

12. The antenna system of claim 11, wherein one of the first node and the third node or the second node and the fourth node are connected in parallel with each of the first and second antenna elements.

13. The antenna system of claim 12, wherein at least one of the first, second and third capacitances are adjustable to fine tune an inductive balance between the first and second antenna elements.

14. The antenna system of claim 12, wherein the first and second capacitance each include a plurality of capacitors all connected in parallel with an adjustable capacitor.

15. The antenna system of claim 12, wherein the balun tuning circuit further comprises:
a plurality of capacitors connected in parallel between a fifth node and the third node; and
a sixth node connected to the first node, wherein the fifth node and the sixth nodes are used to test the balun tuning circuit.

16. The antenna system of claim 12, wherein the balun tuning circuit further comprises:
a first resistor connected between a seventh node and the fourth node;
at least a second resistor connected in parallel with the first resistor; and
an eighth node connected to the second node, wherein the seventh node and the eighth node are used to test the balun tuning circuit.

17. An antenna system, comprising:
a first antenna element;
a second antenna element connected in parallel with the first antenna element; and
a balun tuning circuit connected in parallel with the first and second antenna elements with one terminal being slidably coupled to a common side of the first and second antenna elements to balance an inductance between the first and second antenna elements.

18. The antenna system of claim 17, wherein the first and second antenna elements are formed to substantially avoid a concentration of electromagnetic energy at locations where each of the elements are shaped to respectively form a first antenna loop and a second antenna loop.

19. The antenna system of claim 17, wherein the first and second antenna elements are each formed with each angle having a predetermined radius to minimize a concentration of electromagnetic energy when the antenna system is radiating electromagnetic energy.

20. The antenna system of claim 17, wherein the first and second antenna elements are formed to communicate with a radio frequency identification (RFID) transponder in any orientation of an antenna element of the transponder.

21. The antenna system of claim 17, wherein the first and second antenna elements are each formed to provide electromagnetic fields that are oriented vertically, horizontally and diagonally.

22. The antenna system of claim 17, wherein the first and second antenna elements are adapted to transmit and receive radio frequency identification (RFID) signals.

23. The antenna system of claim 17, wherein the balun tuning circuit comprises an adjustable capacitive network to fine tune an inductive balance between the first and second antenna elements.

24. The antenna system of claim 17, wherein the balun tuning circuit comprises:
a first capacitance connected between a first node and a second node;
a second capacitance connected between a third node and a fourth node; and
a third capacitance connected between the third node and the fourth node.

25. A balun device, comprising:
a tuning circuit; and
a bracket to couple the tuning circuit to first and second antenna elements,
wherein the bracket is movable relative to the first and second antenna elements to balance an inductance between the first and second elements.

26. The balun device of claim 25, wherein the tuning circuit comprises:
a first capacitance connected between a first node and a second node;
a second capacitance connected between a third node and a fourth node; and
a third capacitance connected between the second node and the fourth node.

27. The balun device of claim 26, wherein one of the first node and the third node or the second node and the fourth node are connectable in parallel with the first and second antenna elements with one of the first node and the third node or the second node and the fourth node being coupled to the first and second antenna elements by the bracket.

28. The balun device of claim 26, wherein at least one of the first, second and third capacitances are adjustable to fine tune an inductive balance between the first and second antenna elements.

29. The balun device of claim 26, wherein the first and second capacitance each include a plurality of capacitors all connected in parallel with an adjustable capacitor.

30. The balun device of claim 26, wherein the balun tuning circuit further comprises:
a plurality of capacitors connected in parallel between a fifth node and the third node; and
a sixth node connected to the first node, wherein the fifth node and the sixth nodes are used to test the balun tuning circuit.

31. The balun device of claim 26, wherein the balun tuning circuit further comprises:
a first resistor;
at least a second resistor connected in parallel with the first resistor between a seventh node and the fourth node; and
a eighth node connected to the second node, wherein the seventh node and the eighth node are used to test the balun tuning circuit.

32. A radio frequency identification (RFID) system, comprising:
a plurality of antenna systems, each pair of antenna systems forming an interrogation zone or write zone; and
a power splitter to alternately drive each antenna system of each pair of antenna systems to expand the interrogation zone or write zone for a selected power or to reduce power or signal strength to operate over a predetermined range of the interrogation or write zone.

33. The RFID system of claim 32, wherein each antenna system of the plurality of antenna systems defines a plane and has a predetermined length in the plane, and wherein each antenna system is aligned adjacent another antenna system of the plurality of antenna systems with their planes substantially parallel to one another and at a selected spacing relative to one another to form the interrogation zone or write zone.

34. The RFID system of claim 33, wherein the power splitter switches at a predetermined frequency to alternately drive each antenna system of each pair of antenna systems at least once before a RFID transponder traverses the interrogation zone or write zone.

35. The RFID system of claim 32, wherein each of the antenna systems comprises:
a first antenna element;
a second antenna element connected in parallel with the first antenna element; and
a balun tuning circuit to balance an inductance between the first and second antenna elements.

36. The RFID system of claim 35, wherein the first and second antenna elements are formed to substantially avoid a concentration of electromagnetic energy at locations where each of the elements are shaped to respectively form a first antenna loop and a second antenna loop.

37. The RFID system of claim 35, wherein the first and second antenna elements are each formed with each angle having a predetermined radius to minimize a concentration of electromagnetic energy when the antenna system is radiating electromagnetic energy.

38. The RFID system of claim 35, wherein the first and second antenna elements are formed to communicate with a RFID transponder in any orientation of an antenna element of the transponder.

39. The RFID system of claim 35, wherein the first and second antenna elements are each formed to provide electromagnetic fields that are oriented substantially vertically, horizontally and diagonally.

40. The RFID system of claim 35, wherein the balun tuning circuit is connected in parallel with the first and second antenna elements.

41. The RFID system of claim 40, wherein one side of the balun tuning circuit is movably coupled to a common side of the first and second antenna elements to balance an inductance between the first and second antenna elements.

42. The RFID system of claim 35, further comprising a sliding tuning bracket adapted to couple the balun tuning circuit to the first and second antenna elements, wherein the sliding tuning bracket is adapted to slide along a common side of the first and second antenna elements to balance an inductance between the first and second antenna elements.

43. The RFID system of claim 35, wherein the balun tuning circuit comprises an adjustable capacitive network to fine tune an inductive balance between the first and second antenna elements.

44. The RFID system of claim 35, wherein the balun tuning circuit comprises:
a first capacitance connected between a first node and a second node;
a second capacitance connected between a third node and a fourth node; and
a third capacitance connected between the second node and the fourth node.

45. The RFID system of claim 44, wherein one of the first node and the third node or the second node and the fourth node are connected in parallel with the first and second antenna elements.

46. The RFID system of claim 44, wherein at least one of the first, second and third capacitances are adjustable to fine tune an inductive balance between the first and second antenna elements.

47. The RFID system of claim 32, wherein one antenna system of each pair of antenna systems is active to transmit a signal to any transponder in the interrogation zone or write zone while another antenna system of each pair of antenna systems is passive, and wherein the power splitter alternately switches the one antenna system and the other antenna system of each pair of antenna systems between being active and passive at a predetermined frequency.

48. The RFID system of claim 47, further comprising a RFID reader to receive any signal from the active or passive antenna system in response to the active one of each pair of antenna systems transmitting a signal to any transponder in the interrogation zone or the write zone and the active or passive antenna system receiving any response signal from the transponder.

49. The RFID system of claim 48, further comprising a return signal coupling device to receive the signal from the passive one of each pair of antenna systems and to transfer the signal to the RFID reader.

50. The RFID system of claim 48, wherein the RFID reader transmits signals to the power splitter to alternately drive each antenna system of each pair of antenna systems to transmit the signals to any transponder in the interrogation zone or write zone.

51. The RFID system of claim 48, wherein the RFID reader is coupled to at least one computer system to control operation of the RFID system.

52. The RFID system of claim 32, further comprising a sensor associated with the interrogation zone or write zone to monitor and record activity in the interrogation zone or write zone.

53. The RFID system of claim 32, further comprising a movement control device to control movement of an object or person associated with a transponder after entering the interrogation zone or write zone.

54. The RFID system of claim 32, further comprising a RFID reader/writer to write data into a memory of a transponder in the interrogation or write zone.

55. The RFID system of claim 32, wherein the power splitter is one of a switch or a multiplexer.

56. A radio frequency identification (RFID) system, comprising:
a plurality of antenna systems, each pair of antenna systems forming an interrogation zone or write zone and wherein each antenna system of each pair includes:
a first antenna element,
a second antenna element connected in parallel with the first antenna element, and
a balun tuning circuit slidably coupled to a common side of the first and second antenna elements to balance an inductance between the first and second antenna elements; and
a power splitter to alternately drive each antenna system of each pair of antenna systems to expand the interrogation zone or write zone for a selected power or to reduce a signal strength or power to operate over a predetermined range of the interrogation or write zone.

57. The RFID system of claim 56, wherein each antenna system of the plurality of antenna systems defines a plane and has a predetermined length in the plane, and wherein each antenna system is aligned adjacent another antenna system of the plurality of antenna systems with their planes substantially parallel to one another and at a selected spacing relative to one another to form the interrogation zone or write zone.

58. The RFID system of claim 57, wherein the power splitter switches at a predetermined frequency to alternately drive each antenna system of each pair of antenna systems at least once before a RFID transponder traverses the interrogation zone or write zone.

59. The RFID system of claim 56, wherein the first and second antenna elements are formed to communicate with a RFID transponder in any orientation of an antenna element of the transponder.

60. The RFID system of claim 56, further comprising a sliding tuning bracket adapted to couple the balun tuning circuit to the first and second antenna elements, wherein the sliding tuning bracket is adapted to slide along a common side of the first and second antenna elements to balance an inductance between the first and second antenna elements.

61. The RFID system of claim 56, wherein the balun tuning circuit comprises an adjustable capacitive network to fine tune an inductive balance between the first and second antenna elements.

62. The RFID system of claim 56, wherein one antenna system of each pair of antenna systems is active to transmit a signal to any transponder in the interrogation zone or write zone while another antenna system of each pair of antenna systems is passive, and wherein the power splitter alternately switches the one antenna system and the other antenna system of each pair of antenna systems between being active and passive at a predetermined frequency.

63. The RFID system of claim 62, further comprising a RFID reader to receive any responsive signal from the active or passive antenna system of each pair of antenna systems in response to the active antenna system of each pair of antenna systems transmitting the signal to any transponder in the interrogation zone or the write zone and the active or passive antenna system of each pair of antenna systems receiving any responsive signal from the transponder.

64. The RFID system of claim 63, wherein the RFID reader transmits signals to the power splitter to alternately drive each antenna system of each pair of antenna systems to transmit the signals to any transponder in the interrogation zone or write zone.

65. A method of communicating with a transponder, comprising:
alternately driving each antenna system of at least one pair of antenna systems forming an interrogation zone or write zone;
transmitting a signal to any transponder in the interrogation zone or write zone; and
controlling movement of an object or person associated with the transponder in the interrogation zone or write zone in response to a signal from the transponder.

66. The method of claim 65, wherein alternately driving each antenna system comprises powering one antenna system of the at least one pair of antenna systems to being active to transmit a signal while another antenna system of the at least one pair of antenna systems is passive and alternately switching between the one antenna system and the other antenna system of the at least one pair of antenna systems between being active and passive at a predetermined frequency.

67. The method of claim 65, wherein transmitting a signal to any transponder in the interrogation zone or write zone comprises transmitting an interrogation signal from an active one of the at least one pair of antenna systems.

68. The method of claim 67, further comprising receiving a responsive signal from any transponder in the interrogation zone or write zone in response to transmitting the interrogation signal.

69. The method of claim 68, further comprising receiving the responsive signal with an active or passive antenna system of the at least one pair of antenna systems.

70. The method of claim 65, wherein alternately driving each antenna system comprises switching power between one antenna system and another antenna system of each pair of antenna systems at a predetermined frequency to alternately drive each antenna system at least once before a transponder traverses the interrogation zone or write zone.

71. The method of claim 65, further comprising balancing an inductance between a first antenna element and a second antenna element forming each antenna system by moving a balun tuning circuit along a common side of the first and second antenna elements.

72. A method of communicating with a transponder, comprising:
one of expanding an interrogation zone or write zone for a selected power or reducing a signal strength or power for a predetermined range of the interrogation zone or write zone by alternately driving each antenna system of a pair of antenna systems forming the interrogation zone or write zone; and
one of interrogating or writing into a memory of any transponder in the interrogation zone or write zone.

73. The method of claim 72, further comprising switching power between one antenna system and another antenna system of each pair of antenna systems at a predetermined frequency to alternately drive each antenna system at least once before a transponder traverses the interrogation zone or write zone.

74. A method of making an antenna system, comprising:
forming a first antenna element;
forming a second antenna element connected in parallel with the first antenna element; and
forming a balun tuning circuit connected in parallel with the first and second antenna elements with one terminal being slidably coupled to a common side of the first and second antenna elements to balance an inductance between the first and second antenna elements.

75. The method of claim 74, further comprising forming the first and second antenna elements to substantially avoid a concentration of electromagnetic energy at locations where each of the elements are shaped to respectively form a first antenna loop and a second antenna loop.

76. The method of claim 74, further comprising forming the first and second antenna elements to communicate with a RFID transponder in any orientation.

77. The method of claim 74, wherein forming the balun tuning circuit comprises forming an adjustable capacitive network to fine tune an inductive balance between the first and second antenna elements.

78. The method of claim 74, wherein forming the balun tuning circuit comprises:
forming a first capacitance connected between a first node and a second node;
forming a second capacitance connected between a third node and a fourth node; and
forming a third capacitance connected between the second node and the fourth node.

79. A method of making a balun device, comprising:
forming a tuning circuit; and
forming a bracket to connect the tuning circuit to first and second antenna elements, wherein the bracket is movable relative to the first and second antenna elements to balance an inductance between the first and second elements.

80. The method of claim 79, wherein forming the tuning circuit comprises:
forming a first capacitance connected between a first node and a second node;
forming a second capacitance connected between a third node and a fourth node; and
forming a third capacitance connected between the second node and the fourth node.

81. The method of claim 80, wherein forming the tuning circuit comprises forming at least one of the first, second and third capacitances to be adjustable to fine tune an inductive balance between the first and second antenna elements.

82. The method of claim 79, further comprising forming means to isolate portions of the tuning circuit for testing.

83. A method of making a radio frequency identification (RFID) system, comprising:
forming a plurality of antenna systems, each pair of antenna systems
forming an interrogation zone or write zone; and
forming a power splitter to alternately drive each antenna system of each pair of antenna systems to expand the interrogation zone or write zone for a selected power or to reduce a signal strength or power for a predetermined detection or operating range of the interrogation or write zone.

84. The method of claim 83, further comprising forming the power splitter to switch at a predetermined frequency to alternately drive each antenna system of each pair of antenna systems at least once before a RFID transponder traverses the interrogation zone or write zone.

85. The method of claim 83, wherein forming each antenna system of the plurality of antenna systems comprises:
forming a first antenna element;
forming a second antenna element connected in parallel with the first antenna element; and
forming a balun tuning circuit to balance an inductance between the first and second antenna elements.

86. The method of claim 85, wherein forming the first and second antenna elements comprises forming each element to substantially avoid a concentration of electromagnetic energy at locations where each of the elements are shaped to form a first antenna loop and a second antenna loop.

87. The method of claim 85, wherein forming the first and second antenna elements comprises forming each element to communicate with a transponder in any orientation of an antenna element of the transponder.

88. The method of claim 85, further comprising forming a sliding tuning bracket adapted to couple the balun tuning circuit to the first and second antenna elements, wherein the sliding tuning bracket is adapted to slide along a common side of the first and second antenna elements to balance an inductance between the first and second antenna elements.

89. The method of claim 85, further comprising providing a RFID reader to receive a signal from an active or passive antenna system of each pair of antenna systems in response to an active or driven antenna system of each pair of antenna systems transmitting a signal to interrogate any transponder in the interrogation zone or the write zone and the active or passive antenna system of each pair of antenna systems receiving a response signal from the transponder.
